(19) United States
(12) Patent Application Publication
(10) Pub. No.: US 2024/0121363 A1
(43) Pub. Date: Apr. 11, 2024

(54) MODULAR INFRASTRUCTURE INSPECTION PLATFORM

(71) Applicant: RedZone Robotics, Inc., Warrendale, PA (US)

(72) Inventors: Jianan Lin, Aukland (NZ); Brandon McGannon, Warrendale, PA (US); Charles Hart, Warrendale, PA (US); Jason Mizgorski, Warrendale, PA (US)

(73) Assignee: RedZone Robotics, Inc., Warrnedale, PA (US)

(21) Appl. No.: 18/377,963

(22) Filed: Oct. 9, 2023

Related U.S. Application Data
(60) Provisional application No. 63/414,563, filed on Oct. 9, 2022.

(51) Int. Cl. H04N 7/18; G06T 17/00; H04N 5/265; H04N 23/50

(52) U.S. Cl. CPC H04N 7/181; G06T 17/00; H04N 5/265; H04N 23/555

(57) ABSTRACT

An example implementation includes a device that includes a base infrastructure inspection unit and a plurality of modular sensor units attached to the base infrastructure inspection unit. The base infrastructure inspection unit includes a set of one or more processors and a memory device having code executable by the one or more processors. The executable code synchronizes the plurality of sensor units, captures two or more data streams of infrastructure inspection data, combines the data with metadata indicating synchronization between respective ones of the plurality of sensor units, and provides combined metadata and infrastructure inspection data for inclusion in a photorealistic image based on a three-dimensional (3D) model of the infrastructure.

### CROSS-REFERENCE TO RELATED APPLICATIONS

This application claims priority to U.S. provisional patent application Ser. No. 63/414,563, filed Oct. 9, 2022, and having the same title, the entire contents of which are incorporated by reference herein.

### BACKGROUND

Infrastructure such as storm or wastewater pipes, conduits, tunnels, canals, manholes, or other shafts and chambers need to be inspected and maintained. Visual inspections are often done as a matter of routine upkeep or in response to a noticed issue.

Various systems and methods exist to gather inspection data. For example, inspection data may be obtained by using closed circuit television (CCTV) cameras, sensors that collect visual images, or laser scanning. Such methods include traversing through a conduit or other underground infrastructure asset with an inspection unit and obtaining inspection data regarding the interior, e.g., images and/or other sensor data for visualizing features such as defects, cracks, intrusions, etc. An inspection crew is deployed to a location and individual segments are inspected, often in a serial fashion, in order to collect inspection data and analyze it.

### BRIEF SUMMARY

In summary, an embodiment provides a device, comprising: a base infrastructure inspection unit; and a plurality of modular sensor units attached to the base infrastructure inspection unit; the base infrastructure inspection unit comprising: a set of one or more processors; and a memory device having code executable by the one or more processors to: synchronize the plurality of sensor units; capture, using the plurality of sensor units, two or more data streams comprising infrastructure inspection data; combine the infrastructure inspection data with metadata indicating synchronization between respective ones of the plurality of sensor units; and provide, using a network connection to a remote device, combined metadata and infrastructure inspection data for inclusion in a photorealistic image based on a three-dimensional model (3D) model of the infrastructure.

Another embodiment provides a method, comprising: synchronizing, using a set of one or more processors, a plurality of sensors disposed on a base infrastructure inspection unit; capturing, using the plurality of sensors, two or more data streams comprising infrastructure inspection data; accessing, using the set of one or more processors, a model of infrastructure corresponding to the infrastructure inspection data; selecting, using the one or more processors, data of the plurality of sensors for inclusion in an output based on the model in a photorealistic image; and outputting, using the one or more processors, the photorealistic image of the infrastructure comprising the image data selected.

A further embodiment provides a system, comprising: a base infrastructure inspection unit; a delivery unit configured for attachment with the base infrastructure inspection unit; a plurality of modular sensor units attached to the base infrastructure inspection unit; and a server; the base infrastructure inspection unit comprising: a set of one or more processors; and a memory device having code executable by the one or more processors to: synchronize the plurality of sensor units; capture, using the plurality of sensor units, two or more data streams comprising infrastructure inspection data; combine the infrastructure inspection data with metadata indicating synchronization between respective ones of the plurality of sensor units; and provide, using a network connection to a remote device, combined metadata and infrastructure inspection data; the server being configured to: select data of the plurality of sensors for inclusion in an output based on a model in a photorealistic image; and output the photorealistic image of the infrastructure comprising the image data selected.

The foregoing is a summary and is not intended to be in any way limiting. For a better understanding of the example embodiments, reference can be made to the detailed description and the drawings. The scope of the invention is defined by the claims.

### BRIEF DESCRIPTION OF THE SEVERAL VIEWS OF THE DRAWINGS

FIG. 1 and FIG. 1A illustrate example modular infrastructure inspection devices.

FIG. 2A, FIG. 2B, FIG. 2C, and FIG. 2D illustrate modular infrastructure inspection device examples with differing components.

FIG. 3 illustrates an example method of processing multi-sensor inspection (MSI) data.

FIG. 4 illustrates an example of a display including photorealistic imagery.

FIG. 5 illustrates an example system.

### DETAILED DESCRIPTION

It will be readily understood that the components of the embodiments, as generally described and illustrated in the figures herein, may be arranged and designed in a wide variety of ways in addition to the examples described herein. The detailed description uses examples, represented in the figures, but these examples are not intended to limit the scope of the claims.

Reference throughout this specification to “embodiment(s)” (or the like) means that a particular described feature or characteristic is included in that example. The feature or characteristic may or may not be claimed. The feature may or may not be relevant to other embodiments. For the purpose of this detailed description, each example might be separable from or combined with another example, i.e., one example is not necessarily relevant to other examples.

Therefore, the described features or characteristics of the examples generally may be combined in any suitable manner, although this is not required. In the detailed description, numerous specific details are provided to give a thorough understanding of example embodiments. One skilled in the relevant art will recognize, however, that the claims can be practiced without one or more of the specific details found in the detailed description, or the claims can be practiced with other methods, components, etc. In other instances, well-known details are not shown or described to avoid obfuscation.

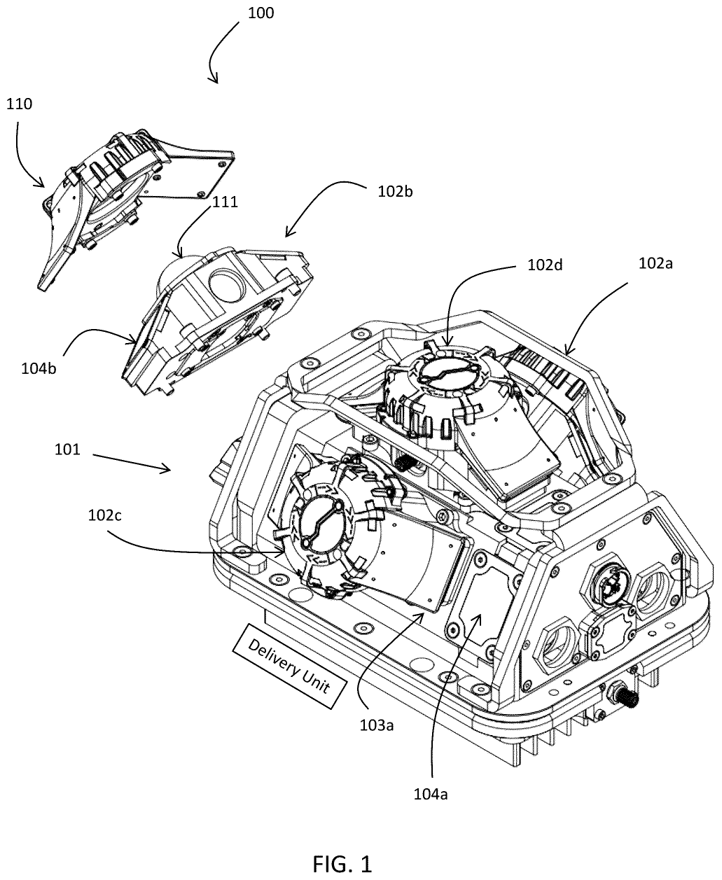

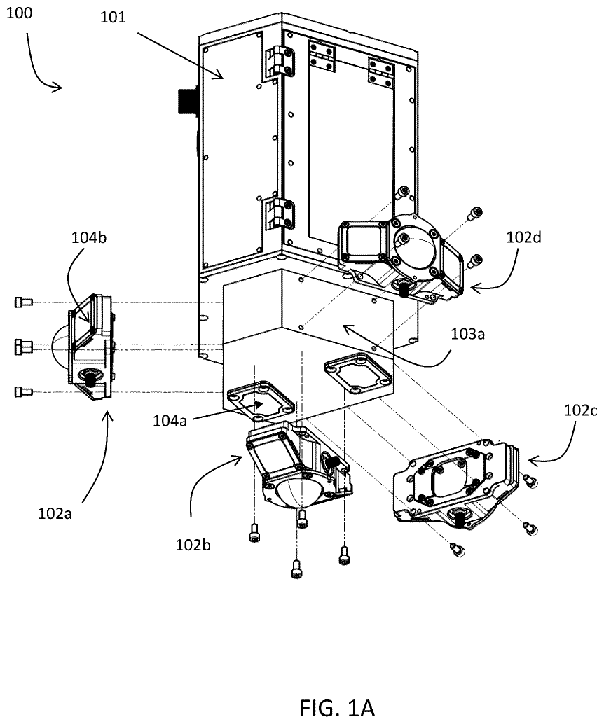

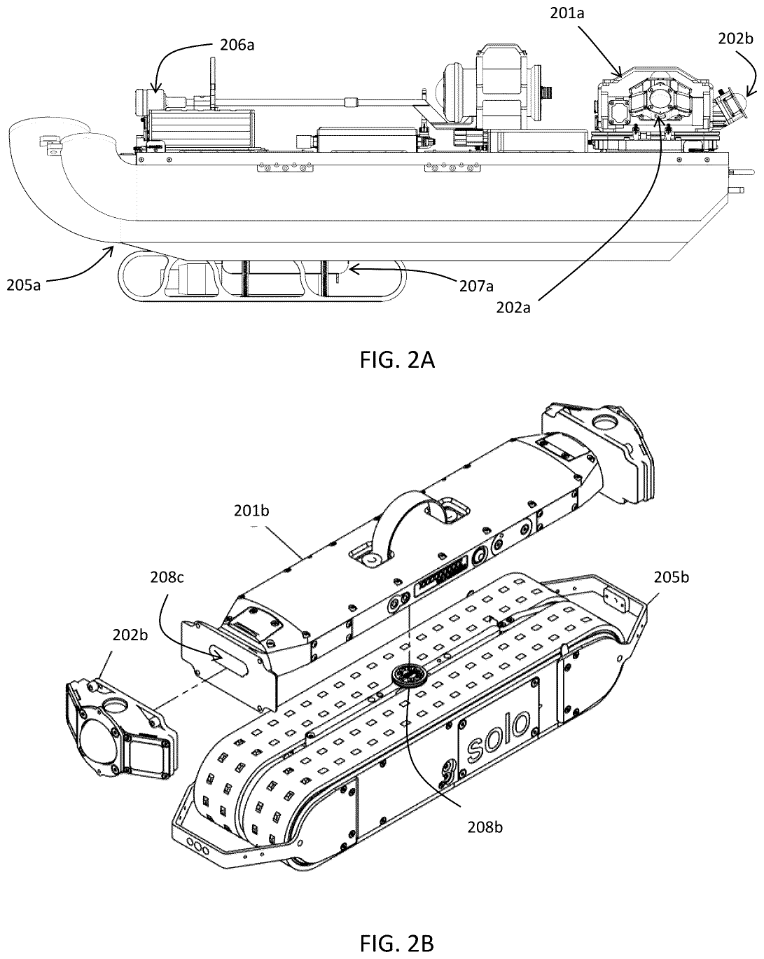

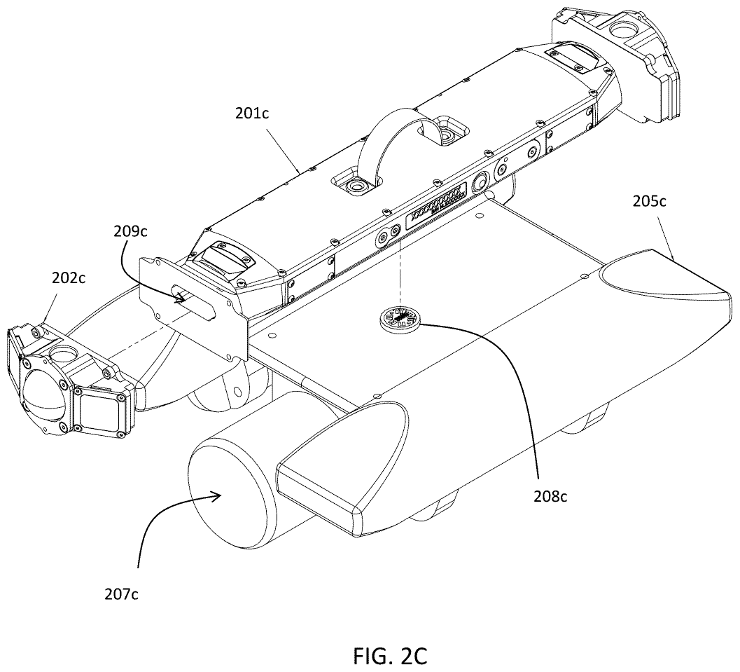

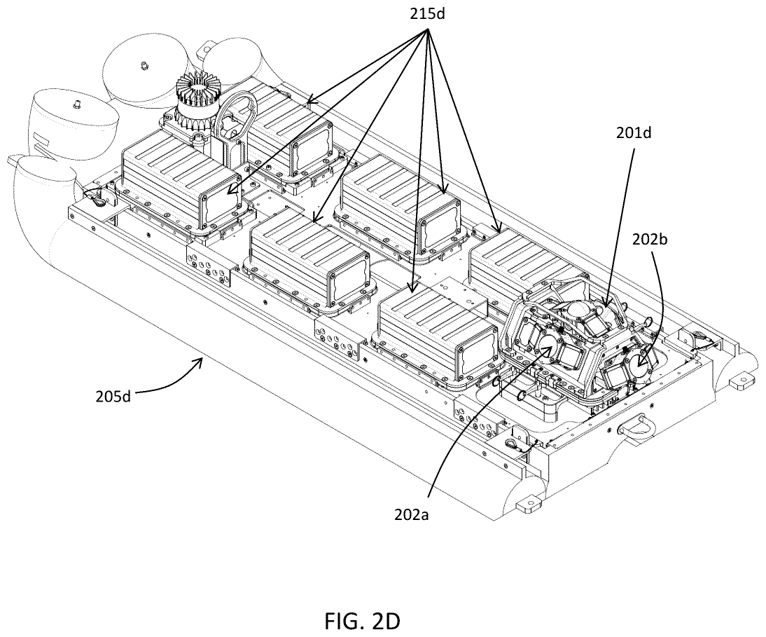

Referring to FIG. 1, an example view is provided in which a system including a modular infrastructure inspection device 100 is provided by an embodiment in the form of a base modular infrastructure inspection device 101 that supports a plurality of sensor units or modules 102a, 102b, 102c, 102d. Sensor unit or module 102b is illustrated in an expanded view to highlight the modularity of these sensor units or modules. Each sensor unit or module 102a-d cooperates to capture sensor data or sensor data streams relating to underground infrastructure. In an embodiment, by way of example, the respective sensor units or modules, e.g., 102a, are included in a modular fashion and attached to and are removable from base infrastructure inspection device 101. The respective sensor units or modules 102a-d in FIG. 1 may be attached to base infrastructure inspection device 101 at an interface, for example indicated at 103a. In an embodiment, differing form factors may be used for base infrastructure device 101, as indicated in FIG. 2A, FIG. 2B, and FIG. 2C, and different interface locations may be utilized, as further described herein.

In the example of FIG. 1, sensor units or modules 1012a, 102c, and 102d are attached radially to angular interfaces, one of which is indicated at 103a. The angled orientation as illustrated provides the combination of sensor modules 102a, 102c, and 102d with wide field of view, for example 180 degree view, with overlapping areas. In combination with sensor unit or module 102b, which may face forward and be angled upwardly, for example at about 45 degrees from a horizontal plane of based device sitting atop a delivery unit, the plurality of sensor units 102a-d allow for imaging a hemispherical, overlapping view of underground infrastructure such as a pipe, lateral or similar horizontal asset as base infrastructure inspection device 101 traverses through the infrastructure asset on a delivery unit. Other orientations for sensor units or modules maybe be chosen, for example via use of different form factors for base infrastructure device 101.

For example, illustrated in FIG. 1A is a base infrastructure inspection device 101 configured with sensor modules or units 102a-d arranged in an orientation that facilitates inspection of vertical infrastructure. For example, base infrastructure inspection device 101 of FIG. 1A may be suspended from a tether and tripod and lowered into a manhole or other vertical chamber, with sensor modules or units 102a-d arranged to capture hemispherical imagery as it descends and/or ascends into and out of the infrastructure asset.

As described herein, the sensor units or modules 102a-d may comprise cameras, lighting units, or other imaging units or sensors to produce data that is coordinated to provide a wide view of the infrastructure for multi-sensor inspection imaging (MSI) of the infrastructure asset. Additional or alternative sensing modules or units may be included, as described in connection with FIG. 2A-C.

Referring again to FIG. 1, in an embodiment, a sensor unit or module, e.g., 102a, includes a vision module having a camera and light emitting element(s), e.g., light emitting element 104a. In one example, a vision module such as sensor module or unit 102b includes a structured laser light projector as light emitting element 104b, for example associated with or disposed within a chamber of the respective vision module.

In an embodiment, a sensor module or unit such as 102a includes a cap 110 that fits onto a chamber housing a camera and respective camera optics (lens) 111. In an embodiment, cap 110 provides a sealing fit (e.g., watertight or gas tight) onto the chamber and can be removed for imaging and/or obtaining other sensor data. In an embodiment, a sensor module or unit, e.g., 102a, includes a pressure sensor. In an embodiment, the pressure sensor provides data allowing an operatively coupled computer system, for example integrated with base infrastructure inspection device 101, to determine if the sensor module chamber and optics remain pressurized or have a leak.

In an embodiment, base infrastructure inspection device 101 is modular in that different sensor modules or units may be paired therewith. For example, sensor modules or units may comprise camera(s), visible light emitter(s), and sensors including one or more of an inertial measurement unit (IMU), one or more pressure sensors (e.g., for sensing a lost seal in sensor module or unit 102a), light detecting and ranging (LIDAR) unit(s), acoustic ranging unit(s) (sonar unit(s)), gas sensor(s), laser profiler(s), or a combination thereof.

As illustrated in FIG. 2A-D, a base infrastructure inspection device, e.g., 101, may be paired with varying delivery units 205a, 205b, 205c. In the example illustrated in FIG. 2A, delivery unit 205a is in the form of a float system, where base infrastructure inspection device 201a is attached to delivery unit 205a to sit on top thereof, with sonar unit 207a and laser profiler 206a included as additional sensor modules or units in addition to vision-based sensors modules or units 202a, 202b, arranged in the orientation shown in FIG. 2A.

As shown in FIG. 2B, delivery unit 205b may take another form, here a tractor unit having tracks covering substantially the entire width of the tractor unit, noting that other tractor units may be used as a delivery unit. In the example of FIG. 2B, base infrastructure inspection device 201b is a smaller form factor than that shown at 101 of FIG. 1, sized appropriately for attachment to delivery unit 205b and having different interfaces for accepting sensor modules or units. As indicated, sensor modules or units, e.g., 202b, may be attached at different locations on base infrastructure inspection device 201b when compared to base infrastructure inspection device 101, for example at the front and rear thereof, via a power and data connection or like interface 208c. Base infrastructure inspection device 201b may in turn be attached to delivery unit 205b via a connector 208b, which may include power and/or data connections or solely be a physical connection. In an embodiment, a universal connector 208b is provided to delivery unit 205b and base infrastructure inspection device 201b such that the various form factors of base infrastructure inspection devices and respective delivery units are interchangeable.

FIG. 2C illustrates another example in which base infrastructure inspection device 201c, similar to FIG. 2B, includes sensor modules or units, e.g., 202c, at the front and back thereof, with sensor modules or units, e.g., 202c, having a complementary connector (not illustrated) that connects or attaches to delivery unit 205c, herein the form of a float or raft system and paired sonar unit 207c. As in the view of FIG. 2B, sensor modules or units, e.g., 202c, may be connected or attached to an interface 209c, similar to interface 208b, of base infrastructure inspection device 201c, offering one or more of power and data.

In the example illustrated in FIG. 2D, delivery unit 205d is in the form of a float system, where base infrastructure inspection device 201d is attached to delivery unit 205d to sit on top thereof, with light detecting and ranging (LIDAR) units included as additional sensor modules or units, in addition to vision-based sensors modules or units 202a, 202b, arranged in the orientation shown in FIG. 2D. As with sensor module or unit 202a attachment to base infrastructure inspection unit 201d, base infrastructure inspection unit 202d may attach to delivery unit 205d or component thereof, e.g., a circuit board or connection port thereof, via an interface to derive power and/or data. In the example of FIG. 2D, delivery unit 205d includes a set of batteries 215d, which may supply power or auxiliary power to base infrastructure inspection device 201d. Likewise, other or additional sensors may derive power and/or data from delivery unit 205d.

As described, base infrastructure inspection devices 101, 201a-c, are modular in that differing sensor modules and/or differing delivery units may be attached thereto. In one example, one or more modules or units, e.g., a delivery unit, may be omitted. For example, in a form factor for vertical manhole inspection where, for example, base infrastructure inspection device 101 is suspended from a tripod by a hook or tether system and lowered and raised into or from a manhole, vertical shaft or chamber, the delivery unit is omitted in favor of suspending base infrastructure inspection device 101 from a cable or tether.

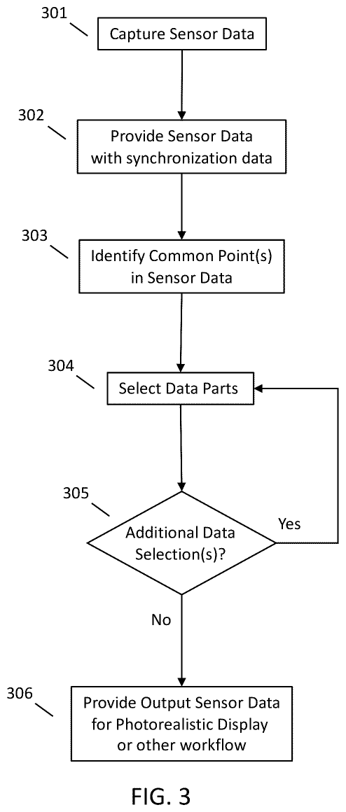

Referring to FIG. 3, the modular infrastructure inspection devices may be used to capture, analyze and display multi-sensor inspection (MSI) data. As shown in FIG. 3, sensor data is captured at 301 using sensor modules or units, e.g., 102a-d. The sensor data may comprise inspection payload data, for example image frames or image frames and audio data (video data) derived from cameras, laser profiling data, sonar data, LIDAR data, gas sensor data, or a combination of the foregoing. The payload data is viewable in a graphical user interface (GUI). The payload data may comprise metadata, for example descriptive data indicating sensor module type, payload data file type or format, etc. Each sensor module may provide different payload data and/or metadata. For example, a sensor module in the form of a vision module with a camera may produce data including the image data and metadata describing the image data, such as time, location, camera, camera position on base infrastructure inspection unit, point of view, camera settings, timing information, etc.

Data used to assist in performing synchronization and data selection may be referred to as synchronization data. At 302 the sensor data, for example payload data, is combined or associated with synchronization data, for example timing metadata used to synchronize data of different sensor modules or units. In an embodiment, metadata includes timing data, for example time stamps utilized to synchronize sensor data capture in a coordinated fashion. The metadata assists in directing an automatic process for coordinating and combining the inspection payload data into a composite image and related display assets, for example a photorealistic image generated by selecting data using a three-dimensional (3D) model. The timing data may be coordinated using a trigger event. In an example, an external trigger is generated by real-time systems running on a microcontroller unit of base infrastructure inspection device 101, which is read by software running on the main processor as well as by the camera multiplexing hardware. In an example, visual and profilometry data are captured on alternating periods following a camera synchronization trigger, to gather data for each stream in a consistent manner. These synchronized visual data streams are combined with the other time-referenced sensor data streams to produce the final output.

Once any pre-processing of the payload and metadata is performed, e.g., converting the various sensor data into a common file format, MSI data is run through a model creation tool or workflow where the sensor data is selected and then outputted to a reporting or visualization GUI for review or further analysis. Metadata from inspection sensors such as deployment, asset, inspection, viewing angle, and timing may be loaded into the workflow.

As shown in FIG. 3, one approach that may be used is to identify common points in sensor data, such as images, at 303 to derive depth information. For example, at 303 common points are identified in stereo image pairs, e.g., frames from one or more of cameras are used to identify overlapping points in the image data. This may include identifying overlap in images from different cameras, identifying overlap in images from the same camera, e.g., as it changes location or viewpoint, of a combination of the foregoing. This visual point data may be used to create a visual point cloud that acts as a model of the infrastructure asset. As one example, common point(s) in image data, such as frames from two or more videos of an infrastructure asset taken via cameras having different points of view, e.g., spaced at a known angle such as 45 or 90 degrees relative to one another, may be obtained as a set of data indicating points for a visual 3D model of the infrastructure asset. In one specific, non-limiting example, image processing software may be utilized to process stereo video data and obtain or identify common points at 303, e.g., as vertices for use in a model. In an embodiment additional data is identified, for example vertices or points, and faces drawn to reference an overall physical structure such as a manhole, tunnel, pipe, or chamber. The locations of the vertices are constructed from the stereo video data content. In an embodiment, each point represents an associated pixel location in 3-D space corresponding to a pixel in an original video frame, which association may be utilized to form an image output, for example as a photorealistic image as further described herein.

In another embodiment, the method includes identifying common points in stereo image data at 303 by a straightforward alignment of frames, e.g., from videos obtained from two adjacent cameras. In other words, the identification of common points at 303 may take the form of identifying points in adjacent frames, e.g., via computer vision, feature identification, and/or frame alignment, for aligning and stitching frames from adjacent cameras together.

At 304 data is selected for inclusion in a GUI output, for example a photorealistic image formed from sensor module or unit data. In the example of images, frames from adjacent cameras or image parts, such as pixels from one or more frames of videos from adjacent images, are aligned. In one example, frames are stitched together at the frame level. In an embodiment, individual pixels or pixel groups are aligned with faces and vertices provided by image metadata, e.g., identified at 303. In one embodiment, the faces and vertices of provided by the image data provide a model framework or mesh with which to select a best pixel from among competing, available frames of adjacent images. Such pixel selections may be made based on, for example, the point of view for a camera more closely aligning with the view of the point within the model's mesh, the pixel aligning with the face connecting to the point, etc. In other words, the model obtained from the original image data is 3D and therefore includes spatial information with which image frames from the video may be aligned with the model given the point of view of the camera to select the best pixel to place back into an output image, making the output image photo-realistic.

As shown at 305, this process may continue until a configured view, for example requested by user input to a GUI, is formed. If additional data, such as image data, is required to fill the view of the GUI, more data is selected. Otherwise, the process may continue to 306 in which an output, such as a photo-realistic image, is provided at 306.

Depending on the technique chosen to align or select image parts at 304, the output image is provided at 306 in a photo-realistic representation of the infrastructure asset as a 3D model populated with selected pixels or as a composite video. In other words, an embodiment may output a photo-realistic image comprising image frames that are aligned, allowing an un-warped (or unwrapped) image view of the 360 degree scene, an embodiment may output a photo-realistic image in the form of a model of faces and vertices populated with image pixel data values to provide a photo-realistic image, or a combination of the foregoing may be provided to produce multiple image outputs.

As may be appreciated, the described techniques permit for densely populating a model to produce a photo-realistic image or visual point cloud representation of an infrastructure asset. In one example, culling may be used to alter the transparency of the photorealistic image or part thereof, e.g., dynamically or via response to user input. This permits adding or removing data from the populated model or part thereof. In one example, culling or removal allows an end user to, e.g., via a GUI element such as a slider or other input element, to look through a front facing wall in a 3D structure to observe a rear facing wall if such imaging or other sensor data is available. As indicated at 306, another workflow may be invoked, for example an auto-coding technique to apply computer vision to automatically detect features of interest, such as defects including but not limited to cracks, instructions, holes, etc., and code the same, for example apply a known feature code to the visualized defect, tagging it as metadata for easy retrieval an visualization.

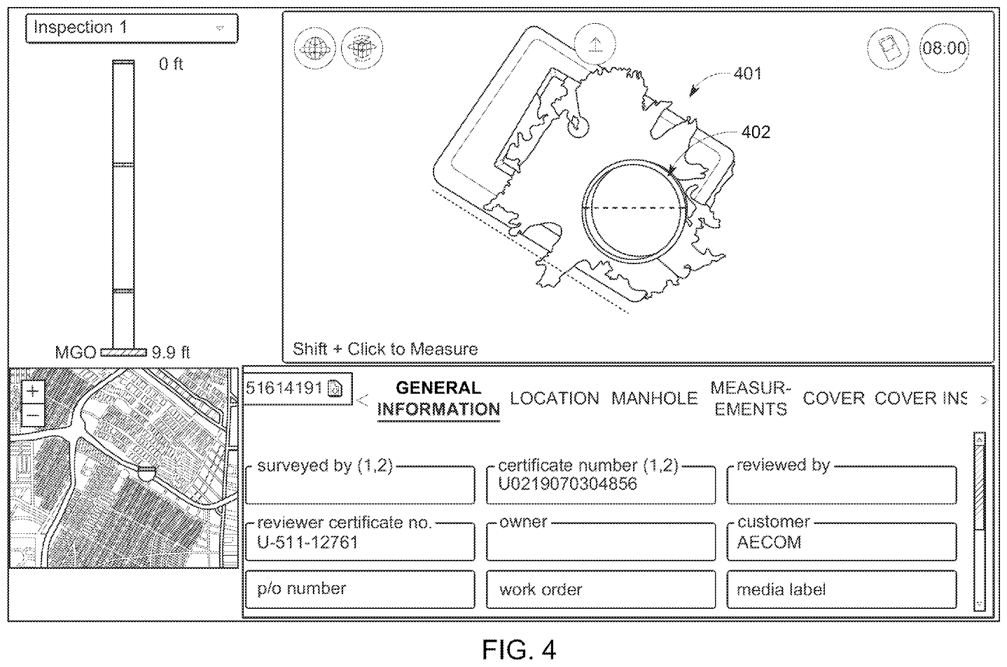

Illustrated in FIG. 4 is an example of a GUI having a photorealistic image 401 displayed therein. The amount of points provided by the photo-realistic image 401 and the structure of the underlying model, e.g., with faces of similar or the same length, a user may highlight or otherwise indicate a feature in the model, such as the manhole's opening, a pipe diameter, a crack or other defect, as illustrated at 402, to have a dimension calculated. Here, a user may indicate a feature of interest, e.g., draw across the opening 402 (indicated by the dashed line in FIG. 4), in order to have the dimension calculated, such as receiving the diameter of the feature in millimeters, centimeters, inches, etc. As may be appreciated, due to the underlying structure of faces or points of the model, which may be evenly spaced for a given resolution, any dimension selected may be used to scale other dimension, e.g., the length of the infrastructure imaged and selected, as indicated with the dotted line in FIG. 4. Alternatively, or additionally, the dimensions of a set of features, e.g., commonly used features such as pipe diameter size, internal chamber size, depth, water level, etc., may be automatically calculated and provided to the user, with or without the need to interface with the model.

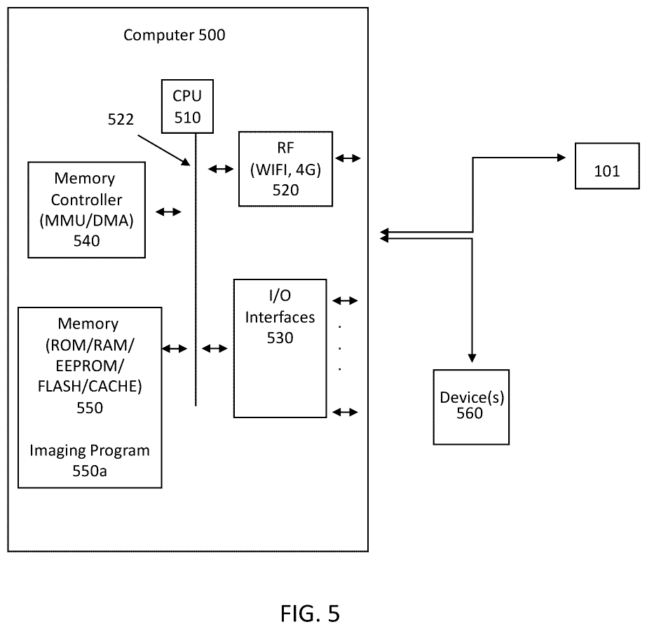

It will be readily understood that certain embodiments can be implemented using any of a wide variety of devices or combinations of devices. Referring to FIG. 5, an example device that may be used in implementing one or more embodiments includes a computing device (computer) 500, for example included in an inspection system 100, such as base infrastructure inspection device 101 as illustrated in FIG. 1, component thereof, and/or a separate system (e.g., a tablet, laptop or desktop computer, a server or workstation, etc.).

The computer 500 may execute program instructions or code configured to store and process sensor data (e.g., images from an imaging device, laser data, sonar data, or point cloud data from a sensor device, as described herein) and perform other functionality of the embodiments. Components of computer 500 may include, but are not limited to, a processing unit 510, which may take a variety of forms such as a central processing unit (CPU), a graphics processing unit (GPU), a combination of the foregoing, etc., a system memory controller 540 and memory 550, and a system bus 522 that couples various system components including the system memory 550 to the processing unit 510. The computer 500 may include or have access to a variety of non-transitory computer readable media. The system memory 550 may include non-transitory computer readable storage media in the form of volatile and/or nonvolatile memory devices such as read only memory (ROM) and/or random-access memory (RAM). By way of example, and not limitation, system memory 550 may also include an operating system, application programs, other program modules, and program data. For example, system memory 550 may include application programs such as image processing software or imaging program 550a, such as a software program for performing some or all of the steps illustrated in FIG. 3. Data may be transmitted by wired or wireless communication, e.g., to or from a base infrastructure inspection device 101 to another computing device, e.g., a remote device or system 560, such as a cloud server that offers image processing, model formation or reference model retrieval, computer vision and auto-coding processing, etc.

A user can interface with (for example, enter commands and information) the computer 500 through input devices such as a touch screen, keypad, etc. A monitor or other type of display screen or device can also be connected to the system bus 522 via an interface, such as interface 530. The computer 500 may operate in a networked or distributed environment using logical connections to one or more other remote computers or databases. The logical connections may include a network, such local area network (LAN) or a wide area network (WAN) but may also include other networks/buses.

It should be noted that various functions described herein may be implemented using processor executable instructions stored on a non-transitory storage medium or device. A non-transitory storage device may be, for example, an electronic, electromagnetic, or semiconductor system, apparatus, or device, or any suitable combination of the foregoing. More specific examples of a non-transitory storage medium include the following: a portable computer diskette, a hard disk, a random-access memory (RAM), a read-only memory (ROM), an erasable programmable read-only memory (EPROM or Flash memory), a portable compact disc read-only memory (CD-ROM), a solid-state drive, or any suitable combination of the foregoing. In the context of this document “non-transitory” media includes all media except non-statutory signal media.

Program code embodied on a non-transitory storage medium may be transmitted using any appropriate medium, including but not limited to wireless, wireline, optical fiber cable, RF, etc., or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN) or the connection may be made through other devices (for example, through the Internet using an Internet Service Provider), through wireless connections, or through a hard wire connection, such as over a USB or another power and data connection.

Example embodiments are described herein with reference to the figures, which illustrate various example embodiments. It will be understood that the actions and functionality may be implemented at least in part by program instructions. These program instructions may be provided to a processor of a device to produce a special purpose machine, such that the instructions, which execute via a processor of the device implement the functions/acts specified.

It is worth noting that while specific elements are used in the figures, and a particular illustration of elements has been set forth, these are non-limiting examples. In certain contexts, two or more elements may be combined, an element may be split into two or more elements, or certain elements may be re-ordered, re-organized, combined or omitted as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting, and that various other changes and modifications may be affected therein by one skilled in the art without departing from the scope or spirit of the disclosure.

What is claimed is:

1. A device, comprising:
a base infrastructure inspection unit; and
a plurality of sensor units attached to the base infrastructure inspection unit;
the base infrastructure inspection unit comprising:
a set of one or more processors; and
a memory device having code executable by the one or more processors to:
synchronize the plurality of sensor units;
capture, using the plurality of sensor units, two or more data streams comprising infrastructure inspection data;
combine the infrastructure inspection data with metadata indicating synchronization between respective ones of the plurality of sensor units; and
provide, using a network connection to a remote device, combined metadata and infrastructure inspection data for inclusion in a photorealistic image based on a three-dimensional model (3D) model of the infrastructure.

2. The device of claim 1, wherein to synchronize comprises using a synchronization trigger to capture the two or more data streams at alternating periods.

3. The device of claim 2, wherein to combine the infrastructure inspection data with metadata comprises including timing data, based on the synchronization trigger, in the metadata to produce time-referenced data of the two or more data streams.

4. The device of claim 1, wherein the plurality of sensor units comprises visual sensor units.

5. The device of claim 1, comprising one or more of a sonar unit, a lidar unit, and a laser profiler.

6. The device of claim 4, wherein:
the plurality of sensor units comprises two or more cameras disposed on the base infrastructure inspection unit such that overlapping views are obtained from the two or more cameras; and
to capture comprises capturing stereo-overlapping images from the two or more cameras.

7. The device of claim 1, comprising a delivery unit configured for attachment with the base infrastructure inspection unit.

8. The device of claim 1, wherein the delivery unit comprises one or more of a float system and a tractor system.

9. The device of claim 1, wherein one or more of the plurality of sensor units is reversibly attachable to the base infrastructure inspection unit.

10. The device of claim 8, wherein the delivery unit comprises a tractor unit having tracks that cover substantially the entire width of the tractor unit.

11. A method, comprising:
synchronizing, using a set of one or more processors, a plurality of sensors disposed on a base infrastructure inspection unit;
capturing, using the plurality of sensors, two or more data streams comprising infrastructure inspection data;
accessing, using the set of one or more processors, a model of infrastructure corresponding to the infrastructure inspection data;
selecting, using the one or more processors, data of the plurality of sensors for inclusion in an output based on the model in a photorealistic image; and
outputting, using the one or more processors, the photorealistic image of the infrastructure comprising the image data selected.

12. The method of claim 1, wherein the synchronizing comprises:
using a synchronization trigger to capture the two or more data streams at alternating periods; and
using timing data associated with the two or more data streams to combine time-referenced data of the two or more data streams to produce a synchronized output.

13. The method of claim 1, wherein the capturing comprises capturing one or more of visual data, sonar data, and laser profiling data.

14. The method of claim 1, wherein:
the plurality of sensors comprise two or more cameras disposed on the base infrastructure inspection unit such that overlapping views are obtained from the two or more cameras; and
the capturing comprises capturing stereo-overlapping images from the two or more cameras.

15. The method of claim 4, comprising deriving distance information for one or more points within the stereo-overlapping images.

16. The method of claim 1, comprising associating the base infrastructure inspection unit with a delivery unit.

17. The method of claim 1, wherein the delivery unit comprises one or more of a float system and a tractor system.

18. The method of claim 1, comprising associating one or more of the plurality of sensors with the base infrastructure inspection unit.

19. The method of claim 8, wherein the associating comprises attaching the one or more of the plurality of sensors to the base infrastructure inspection unit.

20. A system, comprising:
a base infrastructure inspection unit;
a delivery unit configured for attachment with the base infrastructure inspection unit;
a plurality of modular sensor units attached to the base infrastructure inspection unit; and
a server;
the base infrastructure inspection unit comprising:
a set of one or more processors; and
a memory device having code executable by the one or more processors to:
synchronize the plurality of sensor units;
capture, using the plurality of sensor units, two or more data streams comprising infrastructure inspection data;
combine the infrastructure inspection data with metadata indicating synchronization between respective ones of the plurality of sensor units; and
provide, using a network connection to a remote device, combined metadata and infrastructure inspection data;
the server being configured to:
select data of the plurality of sensors for inclusion in an output based on a model in a photorealistic image; and
output the photorealistic image of the infrastructure comprising the image data selected.
